(19) United States
(12) Patent Application Publication
(10) Pub. No.: US 2014/0006625 A1
(43) Pub. Date: Jan. 2, 2014

(54) PROVIDING APPARATUS AND PROVIDING METHOD

(71) Applicant: FUJITSU LIMITED, Kawasaki-shi (JP)

(72) Inventors: Motoaki KOJIMA, Yokohama (JP); Ryohei MORISHITA, Yokohama (JP)

(73) Assignee: FUJITSU LIMITED, Kawasaki-shi (JP)

(21) Appl. No.: 13/872,336

(22) Filed: Apr. 29, 2013

(30) Foreign Application Priority Data
Jun. 28, 2012 (JP) 2012-146010

(51) Int. Cl. H04L 12/911

(52) U.S. Cl. CPC H04L 47/70
USPC 709/226

(57) ABSTRACT

A server device includes a processor configured to specify an application program used by a terminal device, determine an arrangement of symbol images respectively corresponding to application programs, based on association degrees of the application programs with the specified application program, and transmit, to the terminal device, display information including the symbol images in accordance with the determined arrangement.

### CROSS-REFERENCE TO RELATED APPLICATION

This application is based upon and claims the benefit of priority of the prior Japanese Patent Application No. 2012-146010, filed on Jun. 28, 2012, the entire contents of which are incorporated herein by reference.

### FIELD

The embodiment discussed herein is related to providing application programs.

### BACKGROUND

Services that provide an application generally called a gadget or a widget (hereinafter “gadget” is used) to a user at a terminal device via a network are provided. A gadget operates on a page screen, or on a desktop screen of a computer, and addition/deletion of a gadget and changing the arrangement of a gadget can be easily performed. For these features, the user at the terminal device can variously customize the screen by using gadgets.

Many gadgets are developed. Various gadgets are handled at sites (data processing systems) that provide gadgets. Accordingly, a user who wants to add a gadget has difficulty in finding a desired gadget. When the types of gadgets increase as a result of the fact that more various gadgets are developed and provided, it becomes even more difficult for a user to find a desired gadget from among numerous gadgets.

For example, Japanese Laid-open Patent Publication No. 2010-108331 is issued.

### SUMMARY

According to an aspect of the invention, a server device includes a processor configured to specify an application program used by a terminal device, determine an arrangement of symbol images respectively corresponding to application programs, based on association degrees of the application programs with the specified application program, and transmit, to the terminal device, display information including the symbol images in accordance with the determined arrangement.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary configuration of a data processing system according to an embodiment.

FIG. 2 illustrates an exemplary configuration of a portal screen transmitted to a terminal device and a method of determining the arrangement of symbols representing gadgets according to the present embodiment.

FIG. 3 illustrates exemplary details of a gadget database (DB).

FIG. 4 illustrates values used for evaluating the association degree.

FIG. 5 illustrates values used for evaluating the association degree.

FIG. 6 is an exemplary flowchart of a gadget process.

FIG. 7 is an exemplary flowchart of a gadget degree-of-association evaluating process.

FIG. 8 is an exemplary flowchart of a to-be-added-gadget list displaying process.

FIG. 9 illustrates an example of the hardware configuration of a computer to which the present embodiment is applicable.

### DESCRIPTION OF EMBODIMENTS

Hereinafter, an embodiment will be described in detail with reference to the drawings.

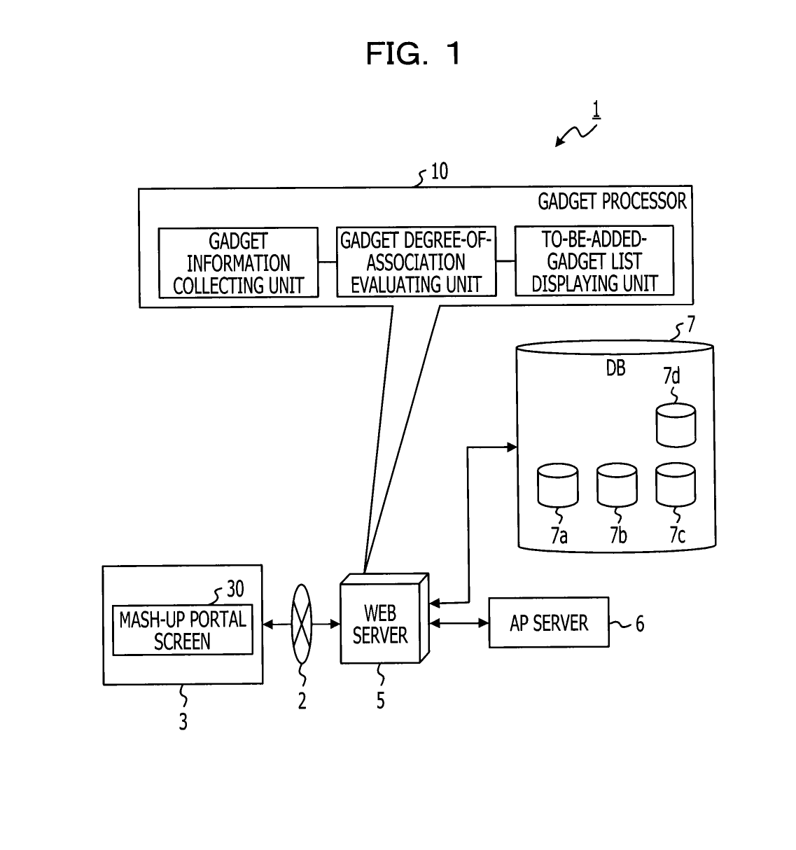

FIG. 1 is a diagram describing an exemplary configuration of a data processing system according to the present embodiment. As depicted in FIG. 1, a data processing system 1 according to the present embodiment is realized as one that performs a service that provides gadgets which are applications to a user of a terminal device 3 connected via a network 2.

Here, it is assumed that the data processing system 1 performs a service that provides a gadget only to a registered user, and the provided gadget operates on a portal screen that is a page screen displayed at first. Because the portal screen can be customized using gadgets, the portal screen may hereinafter also be represented as a “mash-up portal screen”. Reference numeral “30” in FIG. 1 denotes a portal screen transmitted from the data processing system 1 to the terminal device 3.

In the present embodiment, when the portal screen 30 is transmitted to the terminal device 3, a list of gadgets to be added is presented at the terminal device 3.

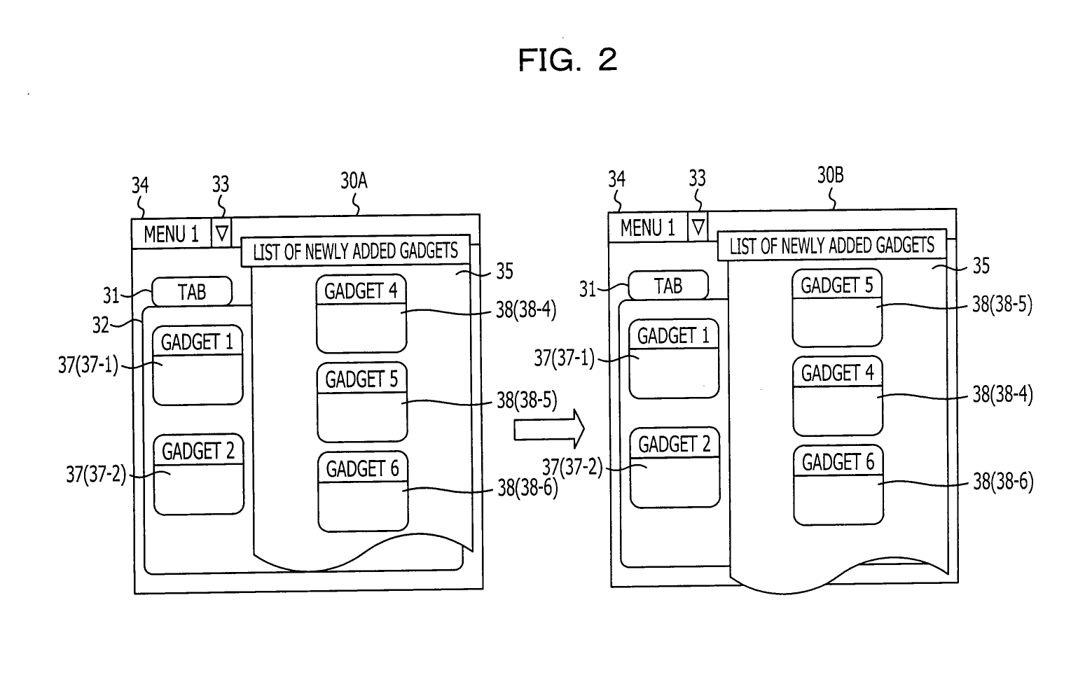

FIG. 2 is a diagram describing an exemplary configuration of the portal screen transmitted to the terminal device and a method of determining the arrangement of symbols representing gadgets according to the present embodiment. Referring to FIG. 2, an exemplary configuration of the portal screen 30 and a method of determining the arrangement of gadgets according to the present embodiment will be specifically described.

In FIG. 2, a portal screen 30A represents the portal screen 30 in the case where the determining method according to the present embodiment is not applied, and a portal screen 30B illustrates the portal screen 30 in the case where the determining method according to the present embodiment is applied.

As depicted in FIG. 2, the portal screen 30 can switch and display multiple sub screens by using tabs 31. On the portal screen 30, the tabs 31, a display region 32 displaying a sub screen, a pull-down menu button 33, and a text box 34 are provided. In the display region 32, an image 37 of a gadget selected by a user is arranged. On both the portal screens 30A and 30B, a gadget image 37-1 represented as “gadget 1” and a gadget image 37-2 represented as “gadget 2” are arranged. In this manner, “gadget 1” to “gadget 6” depicted in FIG. 2 represent different gadgets. Accordingly, a gadget image 37 is specified by using a representation method that adds a hyphen and a numeral after “37”. This representation method is similarly used in other cases, as described below. To simplify the description, “37” and “37-numeral” are also used as reference numerals for gadgets.

To present a gadget 37 to be added, a display region 35 is provided on the portal screen 30. In the display region 35, symbols 38 (38-4 to 38-6) representing gadgets 37 (37-4 to 37-6) to be added are arranged. A symbol 38 is specifically text related to a gadget 37, such as a gadget name, or a capture image of a gadget 37.

On the portal screen 30A, the individual symbols 38 are arranged in accordance with a predetermined rule, that is, in the order of the symbol 38-4, the symbol 38-5, and the symbol 38-6 from the top. In contrast, on the portal screen 30B, the individual symbols 38 are arranged in the order of the symbol 38-5, the symbol 38-4, and the symbol 38-6 from the top. These orders are determined as follows.

On both the portal screens 30A and 30B, the gadgets 37-1 and 37-2 are selected. In the present embodiment, the association degree, in terms of usage, between an already selected gadget(s) 37 and a gadget(s) 37 to be added is evaluated, and the symbol 38 of a gadget 37 with a higher association degree is arranged at a more striking position for the user. Accordingly, on the portal screen 30B, the symbols 38-4 to 38-6 are arranged in the order depicted in FIG. 2. At this time, the association degree has the relationship of the symbol 38-5>the symbol 38-4>the symbol 38-6.

The above-described association degree is, in other words, the degree of possibility of being additionally selected by the user, that is, the degree of expectation. On the basis of a gadget(s) 37 that has/have already been selected by the user, a gadget 37 more likely to be used together with the already selected gadget(s) 37 is preferentially presented, thereby allowing the user to expect to more easily find a desired gadget 37. Accordingly, an environment in which the user can more comfortably use gadgets 37 can be provided to the user.

For example, there are gadgets 37 including a transfer guidance gadget 37 giving guidance in transfer of public transportation, a map gadget 37 displaying a map, and a weather forecast gadget 37 displaying a weather forecast. These gadgets 37 can be used as follows. For example, in response to inputting the place of a departure and a destination to the transfer guidance gadget 37, a map of the destination and its surroundings is displayed on the map gadget 37, and the weather forecast of the destination is displayed on the weather forecast gadget 37. Presenting gadgets 37 in accordance with the association degree facilitates selecting gadgets 37 that can be used in association with one another.

As gadgets 37 used in business operations regarding an organization such as a company, an employee list gadget 37 displaying a list of people belonging to the organization (hereinafter represented as “employees”), a schedule gadget 37 displaying the schedule of each employee, and a sales information gadget 37 displaying sales information of each employee are conceivable. These gadgets 37 can be used as follows. For example, in response to selecting an arbitrary employee in the employee list gadget 37, the schedule of the selected employee is displayed on the schedule gadget 37, and the sales information of the selected employee is displayed on the sales information gadget 37. Presenting gadgets 37 in accordance with the association degree supports such usage.

The symbols 38 can be scrolled and displayed in the display region 35. Accordingly, in the present embodiment, the symbol 38 of a gadget 37 with a higher association degree is arranged in an upper portion of the display region 35. However, the symbols 38 are not necessarily displayed in one column. The display switching method is not limited to scrolling. Accordingly, determination of the arrangement of the symbols 38 focusing on the association degree is preferably changed, as occasion calls, in accordance with how the symbols 38 are displayed, the display switching method, or the like.

As depicted in FIG. 2, the portal screen 30 includes the pull-down menu button 33 and the text box 34. The pull-down menu button 33 is for selecting the category of a gadget 37 whose symbol 38 is to be displayed in the display region 32. In response to clicking the pull-down menu button 33, a list of selectable categories is displayed, and text representing a category selected by the user is displayed in the text box 34. Here, a category is referred to as a “menu item”. “Menu 1” depicted in FIG. 2 represents one menu item.

The portal screen 30 includes the tabs 31. Usable gadgets 37 are divided according to the individual tabs 31. Accordingly, the gadgets 37 are categorized by menu items and the tabs 31.

As described above, the data processing system 1, which presents a list of gadgets 37 to be added, includes a Web server 5, an application server (represented as an “AP server” in FIG. 1) 6, and a database (DB) server 7, as depicted in FIG. 1.

The Web server 5 performs communication with the terminal device 3 via the network 2. The Web server 5 has the function of processing some of requests from the terminal device 3 and transmitting the process results. A gadget processor 10 is the function for performing processing related to providing gadgets to the terminal device 3. The portal screen 30 to be transmitted to the terminal device 3 is generated by the Web server 5 and is transmitted to the terminal device 3.

The AP server 6 is a server provided for dispersing the load on the Web server 5. Processing not to be performed by the Web server 5 is processed by the AP server 6, and the process results are output to the Web server 5.

The DB server 7 is a server that saves various types of data involved in execution of processing performed by the Web server 5 or the AP server 6. The DB server 7 has the function of performing processing requested by the Web server 5 or the AP server 6. The processing includes authentication processing of checking whether a user is registered, in response to a request from the Web server 5.

The DB server 7 stores, in a storage mounted thereon or connected thereto, an authentication DB 7a, a history DB 7b, a gadget group 7c, and a gadget DB 7d.

The authentication DB 7a is a DB that stores personal data for authentication. Personal data includes pieces of data such as the name, address, and the like, besides the identifier (ID) and password.

The history DB 7b is a DB used to save the details of a service provided to a registered user. The details of a service include the gadget ID which is identification information representing a gadget provided to a user. In accordance with the categorization of gadgets 37 as described above, pieces of data including menu affiliation, tab affiliation, and folding (minimization), besides the gadget ID, are saved in the history DB 7b. The menu affiliation represents a menu item to which each gadget 37 belongs. The tab affiliation represents a tab 31 to which each gadget 37 belongs. Among the gadgets 37, there are some gadgets 37 whose gadget images 37 may be folded, that is, whose gadget images 37 may be minimized. Folding is data representing whether folding has been done.

When transmitting a gadget 37 to the terminal device 3 in order to present it, the Web server 5 transmits pieces of data including, for example, the gadget ID, menu affiliation, tab affiliation, folding, and user ID, to the DB server 7, and gives an instruction to update the history DB 7b. A gadget 37 presented to the terminal device 3 may be deleted. When the user deletes a gadget 37, the terminal device 3 reports the gadget ID of the deleted gadget 37 to the Web server 5. In response to this report, the Web server 5 transmits the reported gadget ID, user ID, and the like to the DB server 7, and gives an instruction to update the history DB 7b. When the user changes the status of a gadget 37, that is, when the user changes the status of a gadget 37 from a folded status to a normal status or from a normal status to a folded status, the terminal device 3 reports the gadget ID of the gadget 37 whose status has been changed, and data indicating the change of the status, to the Web server 5. In response to this report, the Web server 5 transmits the gadget ID of the gadget 37 whose status has been changed, the data indicating the change of the status, the user ID, and the like to the DB server 7, and gives an instruction to update the history DB 7b. Accordingly, the Web server 5 can check, for each user, the gadget(s) 37 used by that user and the status of each gadget 37 by referring to the history DB 7b.

The gadget group 7c represents a group of gadgets 37 to be provided to a user. The gadget DB 7d is a DB that stores gadget-related information for each gadget 37.

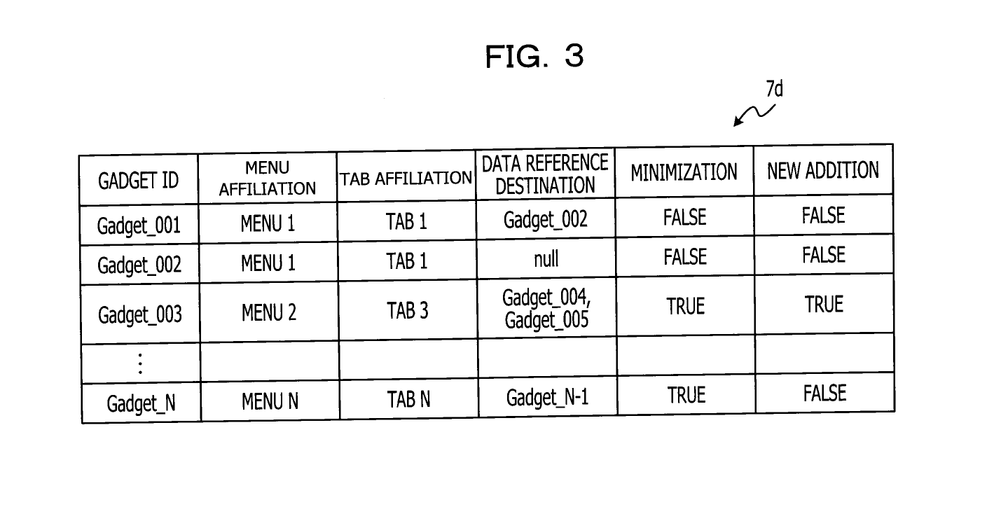

FIG. 3 is a diagram describing exemplary details of the gadget DB 7d. As depicted in FIG. 3, the gadget DB 7d stores, for each gadget 37, pieces of data including the gadget ID, menu affiliation, tab affiliation, data reference destination, minimization (folding), and new addition.

In the data depicted in FIG. 3, the data reference destination is data indicating another gadget 37 or other gadgets 37 whose data may be referred to by a corresponding gadget 37. In FIG. 3, “Gadget_{—}002”, “Gadget_{—}004”, and the like indicate the gadget IDs of gadgets 37 which may serve as data reference destinations, and “null” indicates that there is no gadget 37 which may serve as a data reference destination.

Minimization is data indicating whether a gadget image 37 has been minimized. In FIG. 3, “false” indicates that the gadget image 37 has been minimized, and “true” indicates that the gadget image 37 has not been minimized (normally displayed). New addition is data indicating whether a predetermined period has elapsed since the start of presenting a corresponding gadget 37. In FIG. 3, “false” indicates that the predetermined period has not been elapsed, and “true” indicates that the predetermined period has elapsed.

The above-described association degree is evaluated by referring to the gadget DB 7d and the history DB 7b. The gadget DB 7d stores, for each gadget 37, pieces of data including the gadget ID, menu affiliation, tab affiliation, data reference destination, minimization (such as folding), and new addition. The history DB 7b stores, for each gadget 37 selected by the user, the gadget ID, menu affiliation, tab affiliation, and folding (minimization). To simplify the description, hereinafter, pieces of data that are stored in the gadget DB 7d and related to a gadget 37 are collectively referred to as “basic gadget information”, and pieces of data that are stored in the history DB 7b and related to a gadget 37 are collectively referred to as “user gadget information”.

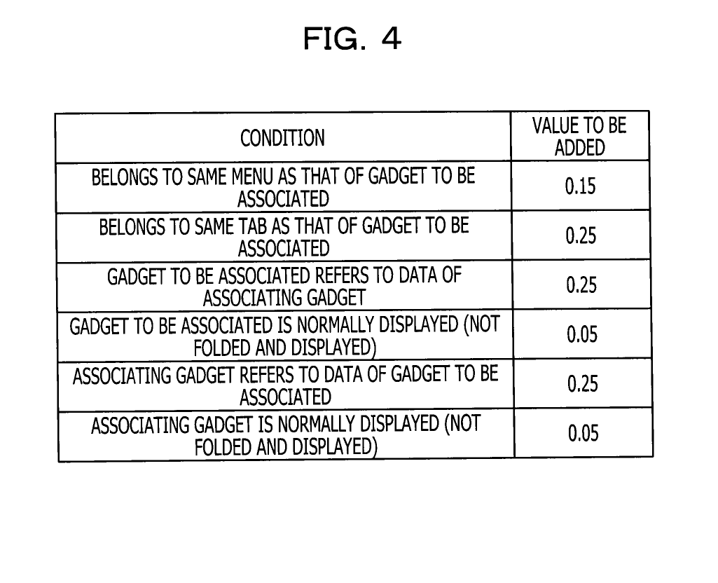

FIG. 4 is a diagram describing values used for evaluating the association degree. In FIG. 4, “a gadget to be associated” represents a gadget 37 that has already been selected by the user, and “an associating gadget” represents an unselected gadget 37 serving as a target of evaluation of the association degree with a selected gadget 37.

In the present embodiment, as depicted in FIG. 4, multiple conditions that are regarded to affect the association degree between two gadgets 37, and values to be added, each representing the degree of the fact that a corresponding one of the conditions is satisfied affects the association degree, are determined as rules of evaluation of the association degree. Accordingly, a cumulative value of the values to be added of conditions satisfied between the two gadgets 37 serves as the association degree.

In the present embodiment, six conditions are determined. The first condition “belongs to the same menu as that of a gadget to be associated” requests that a gadget 37 to be associated and an associating gadget 37 belong to the same menu item. By focusing on this feature, the menu items of gadgets 37 are determined, and this condition is determined by focusing on this feature. The same applies to the second condition “belongs to the same tab as that of a gadget to be associated”. Values to be added in the first and second conditions are 0.15 and 0.25, respectively.

The third condition “a gadget to be associated refers to data of an associating gadget” requests that a gadget 37 to be associated is capable of referring to data of an associating gadget 37. This focuses on, as described above, the fact that multiple gadgets 37 operate in association with one another by referring to data of one another. The same applies to the fifth condition “an associating gadget refers to data of a gadget to be associated”. Values to be added in the third and fifth conditions are both 0.25, which are higher than the other conditions, because of the above feature.

A gadget 37 whose gadget image 37 has been folded and displayed can be regarded as being relatively less useful for the user or relatively less frequently used by the user. This means that, in other words, a gadget 37 whose gadget image 37 has not been folded and displayed, that is, a gadget 37 whose gadget image 37 has been normally displayed, can be regarded as being relatively more useful for the user or relatively more frequently used by the user. The fourth condition “a gadget to be associated is normally displayed (not folded and displayed)” focuses on this feature. The same applies to the sixth condition “an associating gadget is normally displayed (not folded and displayed)”. Values to be added in the fourth and sixth conditions are both 0.05.

Determination of whether the above-described first to sixth conditions are satisfied uses the basic gadget information except for the fourth condition. Determination of only the fourth condition uses the user gadget information.

As long as no associating gadget 37 is used, reference of data of the associating gadget 37 by a gadget 37 to be associated, and reference of data of the gadget 37 to be associated by the associating gadget, are both not performed. Thus, the user gadget information is unusable in determination of the third and fifth conditions.

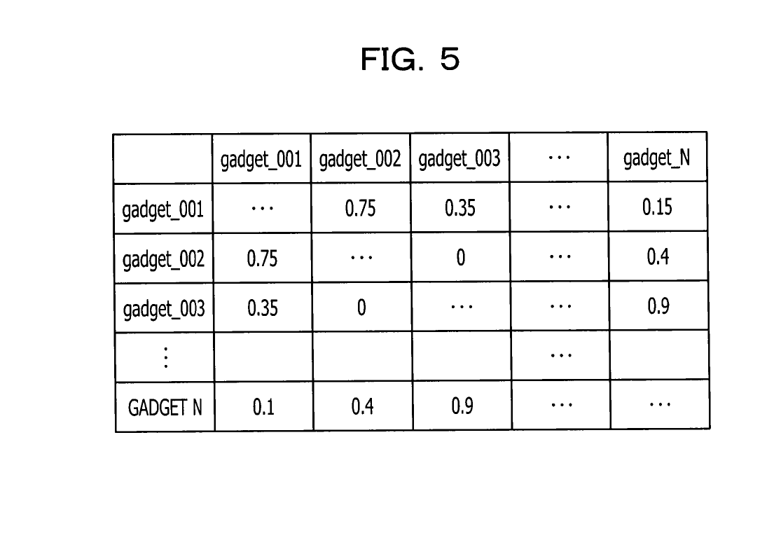

FIG. 5 is a diagram illustrating values used for evaluating the association degree. In FIG. 5, gadget IDs depicted in the top row represent associating gadgets 37, and gadget IDs on the left column represent gadgets 37 to be associated.

The gadget processor 10 mounted on the Web server 5 performs the above-described evaluation of the association degree, and determines the arrangement of the symbols 38 of the gadgets 37 in accordance with the evaluation results. Thus, the gadget processor 10 includes a gadget information collecting unit 11, a gadget degree-of-association evaluating unit 12, and a to-be-added-gadget list displaying unit 13.

The gadget information collecting unit 11 is the function of obtaining the user gadget information in the history DB 7b and the basic gadget information in the gadget DB 7d. The gadget degree-of-association evaluating unit 12 is the function of performing evaluation of each association degree by using the gadget information collected by the gadget information collecting unit 11. The to-be-added-gadget list displaying unit 13 is the function of determining, by using the evaluation result of each association degree, obtained by the gadget degree-of-association evaluating unit 12, the arrangement of the symbols 38 to be arranged in the display region 35, and causing the terminal device 3 to display a list of the symbols 38 in accordance with the determined arrangement.

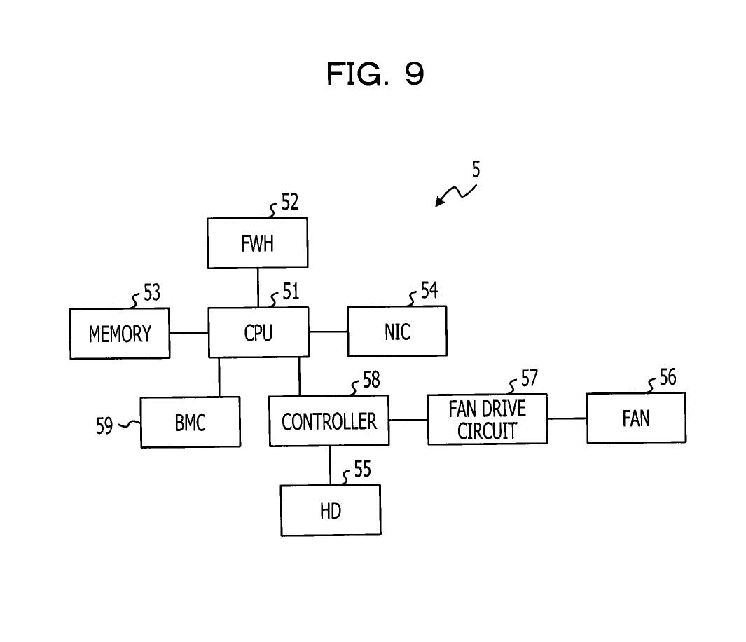

The Web server 5 on which the above-described gadget processor 10 is mounted may be realized by, for example, causing a computer to execute a providing program according to the present embodiment. Referring now to FIG. 9, an example of the hardware configuration of a computer to which the present embodiment is applicable will be specifically described. A providing program according to the present embodiment, which may realize the gadget processor 10, will be referred to as “gadget processing application” hereinafter.

A computer to which the present embodiment is applicable includes, for example, as depicted in FIG. 9, a central processing unit (CPU) 51, a firmware hub (FWH) 52, a memory module (memory) 53, a network interface card (NIC) 54, a hard disk drive (HD) 55, a fan 56, a fan drive circuit 57, a controller 58, and a baseboard management controller (BMC) 59. Such a configuration is only exemplary and is not to be limited as the configuration of a computer usable as the Web server 5. The CPU 51 is an example of a processor that executes the providing program.

The FWH 52 is a memory that stores a basic input/output system (BIOS). The BIOS is read by the CPU 51 to the memory 53 and is executed. The hard disk drive 55 stores an operating system (OS) and various types of application including the above-described Web application. After completion of activation of the BIOS, the CPU 51 may read and execute the OS from the hard disk drive 55 via the controller 58. Communication via the NIC 54 becomes possible in response to activation of the BIOS.

The BMC 59 is a device for management of the computer. The BMC 59 has a communication function and is capable of communicating with an external device via a switch 23. The BMC 59 may activate or deactivate the computer, that is, may turn on or off the power, in response to an instruction from the external device.

In the configuration depicted in FIG. 9, for example, the DB server 7 depicted in FIG. 1 corresponds to the hard disk drive 55. Communication with the terminal device 3 via the network 2 is realized by, for example, the NIC 54. When the OS and the above-described gadget processing application are stored in the hard disk drive 55, the gadget processor 10 is realized by the CPU 51, the FWH 52, the memory 53, the controller 58, and the hard disk drive 55. Alternatively, the gadget processing application may be stored in another memory device different from the hard disk drive 55. Alternatively, the gadget processing application may be stored in a portable recording medium and may be obtained via a network from an external device.

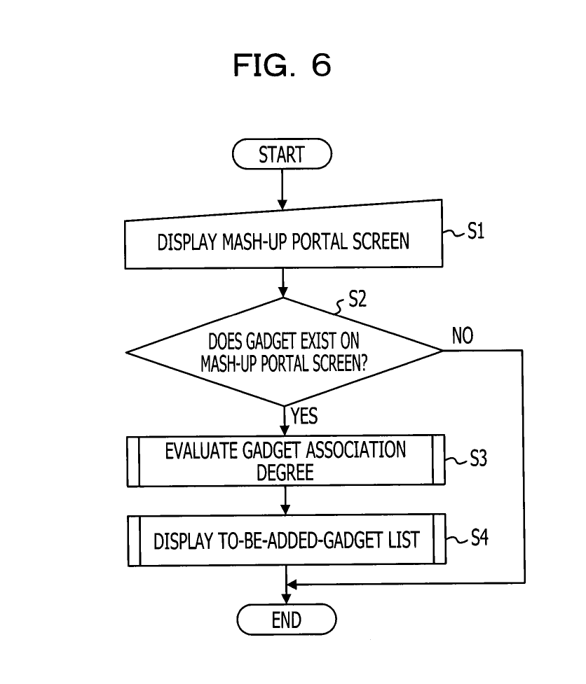

Hereinafter, a process realized by executing the above-described gadget processing application by the CPU 51 will be described in detail with reference to the flowcharts depicted in FIGS. 6 to 8.

FIG. 6 is a flowchart of a gadget process. The gadget process is a process executed when the portal screen 30 on which the display region 35 is arranged is to be displayed on the terminal device 3. The gadget process is executed when, for example, the user clicks on a tab 31 and requests another sub screen to be displayed, or when the user operates the pull-down menu button 33 and changes the menu item. Referring first to FIG. 6, the gadget process will be described in detail.

At first, in S1, the CPU 51 generates a portal screen 30 to be displayed on the terminal device 3, and transmits the portal screen 30 to the terminal device 3. At this time, a portal screen 30 to be generated is one in which symbols 38 are arranged in a display region 35 in accordance with a predetermined rule.

In S2, the CPU 51 determines whether an already-selected gadget 37 exists on the transmitted portal screen 30. Generation of the portal screen 30 is performed by referring to user gadget information stored in the history DB 7b. When an already-selected gadget image 37 has been arranged on the generated portal screen 30, determination in S2 is Yes, and the process proceeds to S3. When no already-selected gadget image 37 has been arranged on the generated portal screen 30, determination in S2 is No, and the gadget process ends here.

In S3, the CPU 51 executes a gadget degree-of-association evaluating process for evaluating the association degree between the already-selected gadget 37 and another gadget 37. In S4, the CPU 51 executes a to-be-added-gadget list displaying process. The to-be-added-gadget list displaying process is a process for determining the symbols 38 of gadgets 37 in accordance with the association degree obtained by executing the gadget degree-of-association evaluating process, and for displaying the symbols 38 in accordance with the determined arrangement on the terminal device 3. By executing the to-be-added-gadget list displaying process, the portal screen 30 displayed on the terminal device 3 can be updated from the portal screen 30A to the portal screen 30B, as depicted in FIG. 2. After execution of the to-be-added-gadget list displaying process, the gadget process ends.

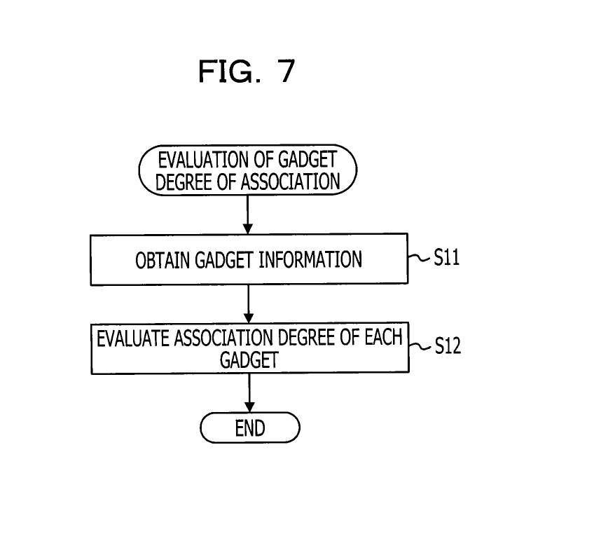

FIG. 7 is a flowchart of the gadget degree-of-association evaluating process. Referring next to FIG. 7, the gadget degree-of-association evaluating process executed as S3 described above will be described in detail.

Firstly, in S11, the CPU 51 obtains basic gadget information from the DB server 7. Only the basic gadget information is obtained because the user gadget information has already been obtained for generating the portal screen 30.

In S12, the CPU 51 refers to the individual conditions depicted in FIG. 4, and evaluates the association degree between the already-selected gadget 37 and another gadget 37. Thereafter, the gadget degree-of-association evaluating process ends.

Accordingly, the gadget information collecting unit 11 is realized by executing S1 and S11 by the CPU 51. The gadget degree-of-association evaluating unit 12 is realized by executing S12 by the CPU 51.

Note that, because the user can add/delete a gadget 37 and change the status of a gadget 37 at any time in the present embodiment, the association degree is calculated when a list of symbols 38 is displayed. Alternatively, the association degree may be calculated at different timing. For example, the association degree may be calculated when the user adds/deletes a gadget 37 or changes the status of a gadget 37. Alternatively, when the association degree adopts an evaluation method that does not affect the display status of each symbol 38, it may be unnecessary to calculate the association degree. That is, the association degree between gadgets 37 may be obtained as data. Accordingly, the association degree between gadgets 37 may be saved in the hard disk drive 55. When the association degree is calculated as occasion calls, because the association degree is stored in the memory 53, it is configured that the association degree is saved in a memory.

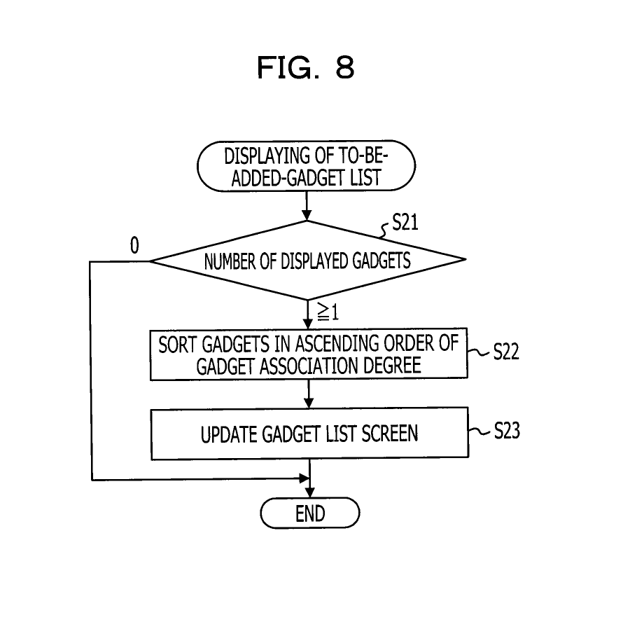

FIG. 8 is a flowchart of the to-be-added-gadget list displaying process. Referring to FIG. 8 at last, the gadget list displaying process executed as S4 in FIG. 6 will be described in detail.

Firstly, in S21, the CPU 51 determines the number of gadgets 37 whose symbols 38 are arranged in the display region 35. When there is currently no gadget 37 to be added, which belongs both to the menu item and the tab 31 serving as targets, the number determined in S21 is zero, and the gadget list displaying process ends here. When there is currently a gadget 37 to be added, which belongs both to the menu item and the tab 31 serving as targets, the number determined in S21 is one or more, and the process proceeds to S2.

In S22, the CPU 51 determines the arrangement of the symbols 38 of the individual gadgets 37 by sorting the symbols 38 of gadgets 37 in ascending order of the association degree. In S23, the CPU 51 generates a portal screen 30 in which the individual symbols 38 are arranged in accordance with the determined arrangement in the display region 35, and transmits the portal screen 30 to the terminal device 3. Thereafter, the gadget list displaying process ends.

Accordingly, the to-be-added-gadget list displaying unit 13 depicted in FIG. 1 is realized by executing the above-described to-be-added-gadget list displaying process by the CPU 51.

Note that, although the association degree between gadgets 37 is evaluated for each user in the present embodiment, when a group to which each user belongs is clear and when imbalance can be expected in gadgets 37 used by people belonging to groups, the association degree may be evaluated on a group by group basis. That is, the arrangement of symbols 38 may be determined using the association degree evaluated on a group by group basis. In order that a group to which each user belongs may be specifiable, personal data may include data indicating to which group the user belongs. Alternatively, users may be classified on the basis of personal data.

Although conditions are set in advance in order to evaluate the association degree between gadgets 37 in the present embodiment, the association degree may be evaluated without setting conditions in advance. For example, the tendency of a combination of gadgets 37 selected by each user may be analyzed, and, using the analysis results, the association degree between gadgets 37 may be evaluated. The analysis results may be reflected in the result of evaluating the association degree for which conditions are set in advance. Accordingly, various modifications of the method of evaluating the association degree are possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A server device comprising:
a processor configured to:
specify an application program used by a terminal device;
determine an arrangement of symbol images respectively corresponding to application programs, based on association degrees of the application programs with the specified application program; and
transmit, to the terminal device, display information including the symbol images in accordance with the determined arrangement.

2. The server device according to claim 1, wherein
the association degrees are determined based on a reference relationship between the application programs and the specified application program.

3. The server device according to claim 1, wherein
the application programs are candidate application programs for being used by the terminal device.

4. A method comprising:
specifying an application program used by a terminal device;
determining, by a processor, an arrangement of symbol images respectively corresponding to application programs, based on association degrees of the application programs with the specified application program; and
transmitting, to the terminal device, display information including the symbol images in accordance with the determined arrangement.

5. The method according to claim 4, wherein
the association degrees are determined based on a reference relationship between the application programs and the specified application program.

6. The method according to claim 4, wherein
the application programs are candidate application programs for being used by the terminal device.

7. A computer-readable recording medium storing a program that causes a computer to execute a procedure, the procedure comprising:
specifying an application program used by a terminal device;
determining an arrangement of symbol images respectively corresponding to application programs, based on association degrees of the application programs with the specified application program; and
transmitting, to the terminal device, display information including the symbol images in accordance with the determined arrangement.

8. The recording medium according to claim 7, wherein
the association degrees are determined based on a reference relationship between the application programs and the specified application program.

9. The recording medium according to claim 7, wherein
the application programs are candidate application programs for being used by the terminal device.
